(19) United States
(12) Patent Application Publication
(10) Pub. No.: US 2020/0056083 A1
(43) Pub. Date: Feb. 20, 2020

(54) GEOPOLYMER COMPOSITIONS AS INORGANIC BINDING MATERIAL FOR FORMING PROPPANT AGGREGATES

(71) Applicant: Halliburton Energy Services, Inc., Houston, TX (US)

(72) Inventors: Tatyana V Khamatnurova, Houston, TX (US); Philip D Nguyen, Houston, TX (US); Thomas Jason Pisklak, Cypress, TX (US)

(73) Assignee: Halliburton Energy Services, Inc., Houston, TX (US)

(21) Appl. No.: 16/089,974

(22) PCT Filed: Jun. 30, 2016
(86) PCT No.: PCT/US2016/040380

§ 371 Date: Sep. 28, 2018

(51) Int. Cl. C09K 8/46; C09K 8/68; C09K 8/80; C09K 8/42; C09K 8/40; C09K 8/60; C04B 28/00; E21B 43/267

(52) U.S. Cl. CPC C09K 8/46; C09K 8/685; C09K 8/805; E21B 43/267; C09K 8/40; C09K 8/601; C04B 28/006; C09K 8/424

(57) ABSTRACT

The present disclosure relates to a method of treating a subterranean formation comprising creating at least one fracture in the subterranean formation, providing a fracturing fluid comprising proppant particulates and a geopolymer composition coated on the proppant particulates, wherein the geopolymer composition comprises an aluminosilicate source, a metal silicate source, and an activator, alternately injecting a spacer fluid and the fracturing fluid into the fracture such that a plurality of proppant aggregates are disposed in the fracture surrounded by the spacer fluid, wherein the proppant aggregates each comprise a portion of the proppant particulates coated with a volume of the geopolymer composition; and allowing the geopolymer composition to set in the formation such that the proppant aggregates gain consolidation strength.

### BACKGROUND

After a well bore is drilled, it may be necessary to fracture the subterranean formation to enhance hydrocarbon production. This may be of greater importance in shale formations that typically have high-closure stresses. Access to the subterranean formation can be achieved by first creating an access conduit (e.g., perforations) from the well bore to the subterranean formation. Then a fracturing fluid, called a pad, may be introduced at pressures exceeding those required to maintain matrix flow in the subterranean formation to create or enhance at least one fracture that propagates from the well bore. The pad fluid may be followed by a fracturing fluid comprising proppant particulates to prop the fracture or fractures open after the pressure is reduced. The proppant particulates hold the fracture (or fractures) open, thereby maintaining the ability for hydrocarbons to flow through the fracture(s) to ultimately be produced at the surface.

### BRIEF DESCRIPTION OF THE DRAWINGS

These drawings illustrate certain aspects of some of the embodiments of the present method, and should not be used to limit or define the method.

FIG. 1 is a schematic illustration of example proppant aggregates disposed in a fracture.

FIG. 2 is a schematic illustration of an example proppant-free channel formed in a fracture.

FIG. 3 is a schematic illustrating showing intermittent introduction of a fracturing fluid into a fracture.

FIG. 4 is a schematic illustration of an example of system for delivering fracturing fluids.

### DETAILED DESCRIPTION

The systems, methods, and/or compositions disclosed herein may relate to subterranean operations and, in some systems, methods, and compositions, to introduction of a fracturing fluid comprising proppant particles coated with a geopolymer composition into a subterranean formation penetrated by a wellbore. As used herein, the term “coat,” “coating, “coated” or the like is not intended to imply in particular degree of coating, but rather means that the geopolymer composition is adhered to at least some portion of the proppant particulates. The fracturing fluid may be used as part of a fracturing operation to enhance the communication between a primary fracture and the remainder of the corresponding complex fracture network. This disclosure also provides methods of applying or coating the geopolymer composition on proppant particles to create proppant aggregates. The proppant aggregates may have high consolidation strength relative to uncoated proppant particulates.

Oftentimes, it may be advantageous to consolidate proppant particulates once placed in a subterranean formation. Consolidated proppant particulates may be less likely to migrate through the propped fractures and cause production problems. Very fine particles present in the proppant particulates and formation may be especially detrimental to production as they are highly mobile and may cause blockages in the subterranean formation and propped fractures. The blockage may lead to a decreased permeability. The production of solid particles through a wellbore may damage equipment such as pumps, shoes, casings, liners, and other downhole equipment as well as damaging surface equipment such as pumps, tanks, separators, and the like. Therefore, the reduction or elimination of particle migration may prevent a decrease in permeability over time and reduced equipment damage. The reduction of particle migration may result in longer production life for a well and less operational expenditure. Consolidation may involve treatment of the subterranean formation or proppant particulates with a binding agent that will set with time and temperature to form a rigid mass. As will be appreciated by one of ordinary skill in the art, resins such as bisphenol-A resins have been used as consolidating agents with great success.

As disclosed herein, geopolymer compositions may take the place of resins in some applications and may be especially suitable where high consolidation strength and thermal stability is needed. A fracturing fluid may comprise a base fluid, proppant particulates, and a geopolymer composition. The geopolymer composition may be coated on the proppant particulates such that the proppant aggregates comprising the proppant particulates adhered to one another by the geopolymer composition (and ultimately the resultant geopolymer) are formed in the fracture.

The geopolymer composition may comprise an aluminosilicate source, a metal silicate source, and an activator. The geopolymer composition may react to form a geopolymer. A geopolymer is an inorganic polymer that forms long-range, covalently bonded, non-crystalline networks. The production of a geopolymer is known as geosynthesis, a reaction process that may involve naturally occurring aluminosilicates. Geopolymers may be formed by chemical dissolution and subsequent re-condensation of various aluminosilicates and silicates to form a 3D-network or three-dimensional mineral polymer. Geopolymers based on aluminosilicates may be designed as poly(silate), which is a shorter version of poly(silicon-oxo-aluminate). The silate network may comprise silicate and aluminate tetrahedrals linked alternately by sharing all oxygens, with Al³⁺ and Si⁴⁺ in IV-fold coordination with oxygen. A general geosynthesis reaction, which may not be representative of all geosynthesis reactions, is presented below in Equation 1. In equation 1, aluminate, silicate, and metal hydroxide react to form the geopolymer.

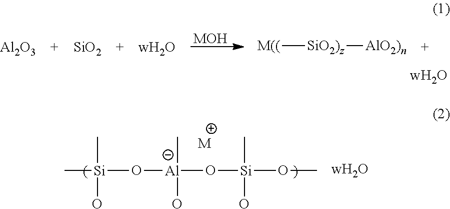

In equation 1, the metal hydroxide, MOH, may comprise group 1 and 2 hydroxides. Some suitable hydroxides may include, but are not limited to, potassium hydroxide, sodium hydroxide, and calcium hydroxide. The degree of polymerization is denoted by n and the atomic ratio of Si to Al is denoted by z. The metal hydroxide may act as an activator for the geosynthesis reaction and as a stabilizing agent to the final polymer matrix. Equation 2 illustrates how the metal ion may act as a counter ion to counterbalance the negative charge of the aluminum metal. The geosynthesis reaction may be kinetically favored due to the presence of the counter anion. Other compounds may act as activators and may include, but are not limited to, chloride salts such as KCl, CaCl₂, NaCl, carbonates such as Na₂CO₃, silicates such as sodium silicate, aluminates such as sodium aluminate, and ammonium hydroxide. In each case, the cation in the compound may also act as a counter anion. In some examples, a metal hydroxide and salt may be used together. In other examples, combinations of any salts, silicates, carbonates, aluminates, metal hydroxides, and ammonium hydroxide may The activator may be dry mixed with the other geopolymer components to make the geopolymer composition. In other examples, the activator may be in an aqueous solution. The activator may be included in an amount in the range of from about 1% to about 20% by weight of the geopolymer composition. Some geopolymer compositions may have an activator included in amounts of about 1% to about 5%, about 5% to about 10%, about 10% to about 15%, about 15% to about 20%, or about 10% to about 20% by weight of the geopolymer composition. With the benefit of this disclosure, one of ordinary skill in the art should be able to select an appropriate activator for any particular application.

The aluminosilicate source may comprise any suitable aluminosilicate. Aluminosilicate is a mineral comprising aluminum, silicon, and oxygen, plus counter-cations. There are potentially hundreds of suitable minerals that may be an aluminosilicate source in that they may comprise aluminosilicate minerals. Each aluminosilicate source may potentially be used in a particular case if the specific properties, such as composition, may be known. Some minerals such as andalusite, kyanite, and sillimanite are naturally occurring aluminosilicate sources that have the same composition, Al₂SiO₅, but differ in crystal structure. Each mineral andalusite, kyanite, or sillimanite may react more or less quickly and to different extents at the same temperature and pressure due to the differing crystal structures. The final geopolymer created from any one aluminosilicate may have both microscopic and macroscopic differences such as mechanical strength and thermal resistivity owing to the different aluminosilicate sources. Aluminosilicate may be a major component of kaolin and other clay minerals. Partially calcined clays such as kaolin may be an especially cost-effective and readily available aluminosilicate source. Other suitable aluminosilicate sources may include, but are not limited to, calcined clays, partially calcined clays, kaolinite clays, lateritic clays, illite clays, volcanic rocks, mine tailings, blast furnace slag, and coal fly ash. The aluminosilicate source may be present in an amount in the range of from about 1% to about 80% by weight of the geopolymer composition. Some geopolymer compositions may have the aluminosilicate source present in about 1% to about 10%, about 10% to about 20%, about 20% to about 30%, about 30%, to about 40%, about 40% to about 50%, about 50% to about 60%, about 60% to about 70%, about 70% to about 80%, or about 40% to about 80% by weight of the geopolymer composition. For each geopolymer application the individual components must be evaluated. One of ordinary skill in the art with the benefit of this disclosure should be able to select an aluminosilicate source and concentration that is appropriate for a particular application.

The metal silicate source may comprise any suitable metal silicate. A silicate is a compound containing an anionic silicon compound. Some examples of a silicate include the orthosilicate anion also known as silicon tetroxide anion, Sia⁴⁻ as well as hexafluorosilicate [SiF₆]²⁻. Other common silicates include cyclic and single chain silicates which may have the general formula [SiO₂₊ₙ]²ⁿ⁻ and sheet-forming silicates ([SiO_{2.5}]⁻)ₙ. Each silicate example may have one or more metal cations associated with each silicate molecule. Some suitable metal silicate sources and may include, without limitation, sodium silicate, magnesium silicate, and potassium silicate. The metal silicate source may be present in an amount in the range of from about 1% to about 80% by weight of the geopolymer cement composition. Some geopolymer compositions may have the metal silicate source present in about 1% to about 10%, about 10% to about 20%, about 20% to about 30%, about 30%, to about 40%, about 40% to about 50%, about 50% to about 60%, about 60% to about 70%, about 70% to about 80%, or about 40% to about 80% by weight of the geopolymer composition. For each geopolymer application the individual components must be evaluated. One of ordinary skill in the art with the benefit of this disclosure should be able to select a metal silicate containing source and concentration that is appropriate for a particular application.

The geopolymer composition may be present in the fracturing fluid in any suitable concentration or loading. Without limitation, the geopolymer may be present in an amount of about 1 pounds per gallon (“lb/gal”) to about 20 lb/gal, about 1 lb/gal to about 5 lb/gal, about 5 lb/gal to about 10 lb/gal, about 10 lb/gal to about 15 lb/gal, about 15 lb/gal to about 20 lb/gal, about 1 lb/gal to about 10 lb/gal, or about 10 lb/gal to about 20 lb/gal. With the benefit of this disclosure, one of ordinary skill in the art should be able to select an appropriate loading.

The components of the geopolymer compositions may be combined in any order desired to form a geopolymer composition that can be placed into a subterranean formation or used as a component of a fracturing fluid. The components of the geopolymer compositions may be combined using any mixing device compatible with the composition, including a bulk mixer, for example. In some examples, a geopolymer composition may be formed by dry blending dry components comprising the aluminosilicate source, the metal silicate source, and an activator. The dry blend of the geopolymer composition may then be combined with water (e.g., tap water, seawater, saltwater, etc.) to form a geopolymer slurry which may be included in a fracturing fluid. In another example, a dry blend of the geopolymer composition may be combined with other components of a fracturing fluid such as proppant particulates and water to form a fracturing fluid. In another example, the dry blend of the geopolymer composition may be combined with proppant particulates and optionally water and mixed to coat the proppant particulates with dry blend in order to form coated proppant particulates. In some examples, the geopolymer composition may be coated on the proppant particulates in an on-the-fly mixer such as a batch mixer or continuous mixer at a well site. In other examples the geopolymer composition may be coated on proppant particulates at a preparation facility and then later transported to the well site. The coated proppant particulates may be included as a component of a fracturing fluid. Other suitable techniques may be used for preparation of the geopolymer compositions as will be appreciated by those of ordinary skill in the art.

As previously mentioned, a dry blend of the geopolymer composition may be mixed with water to form a geopolymer slurry. Those of ordinary skill in the art will appreciate that examples of the geopolymer slurries generally should have a density suitable for a particular application. By way of example, geopolymer slurries may have a density of about 9 pounds per gallon (“lb/gal”) to about 20 lb/gal. The thickening and setting time for a particular geopolymer slurry may be controlled by modifying the slurry density. In general, a relatively thinner composition will take relatively more time to set than a relatively thicker composition. In certain examples, the geopolymer cement slurries may have a density of about 14 lb/gal to about 17 lb/gal. Additionally, a fracturing fluid comprising a geopolymer slurry should have a density appropriate for a particular application. By way of example, fracturing fluids may have a density of about 9 pounds per gallon (“lb/gal”) to about 20 lb/gal. Fracturing fluid densities may be adjusted based on the amount of proppant loading for example. Those of ordinary skill in the art, with the benefit of this disclosure, will recognize the appropriate density for a particular application.

In some embodiments, the geopolymer slurry may have a thickening time of greater than about 1 hour, alternatively, greater than about 2 hours, alternatively greater than about 5 hours at 3,000 psi and temperatures in a range of from about 50° F. to about 400° F., alternatively, in a range of from about 80° F. to about 250° F., and alternatively at a temperature of about 140° F. As used herein, the term “thickening time” refers to the time required for a geopolymer composition to reach 70 Bearden units of Consistency (“Bc”) as measured on a high-temperature high-pressure consistometer in accordance with the procedure for determining cement thickening times set forth in API Recommended Practice 10B-2 (July 2005).

In some examples, the geopolymer compositions may be essentially free of any additional cementitious materials, such as hydraulic cements, including, but not limited to, those comprising calcium, aluminum, silicon, oxygen, iron, and/or sulfur, which set and harden by reaction with water. Specific examples of hydraulic cements include, but are not limited to, Portland cements, pozzolana cements, gypsum cements, high alumina content cements, silica cements, slag cements, and any combination thereof. Furthermore, the geopolymer compositions may be essentially free of cement kiln dust (CKD).

As previously mentioned, a fracturing fluid may comprise a geopolymer composition, a proppant, and a base fluid. Examples of fracturing fluids may include, without limitation, aqueous-based fluids, non-aqueous-based fluids, slickwater fluids, aqueous gels, viscoelastic surfactant gels, foamed gels, and emulsions, for example. Examples of suitable aqueous-based fluids may include fresh water, saltwater, brine, seawater, and/or any other aqueous fluid that may not undesirably interact with the other components used in accordance with the present disclosure or with the subterranean formation. Examples of suitable non-aqueous-based fluids may include organic liquids, such as hydrocarbons (e.g., kerosene, xylene, toluene, or diesel), oils (e.g., mineral oils or synthetic oils), esters, and any combination thereof. Suitable slickwater fluids may generally be prepared by addition of small concentrations of polymers, such as friction reducers, to water to produce what is known in the art as “slickwater.” Suitable aqueous gels may generally comprise an aqueous fluid and one or more viscosifying agent or gelling agents such as, but not limited to, guar gum, hydroxyl propyl guar, carboxymethyl hydroxypropyl guar, hydroxyethyl cellulose, and combinations thereof. Suitable emulsions may be comprised of two immiscible liquids such as an aqueous fluid or gelled fluid and a hydrocarbon. Foams may be created by the addition of a gas, such as carbon dioxide or nitrogen. Additionally, the fracturing fluid may be an aqueous gel comprised of an aqueous fluid, a gelling agent for gelling the aqueous fluid and increasing its viscosity, and, optionally, a crosslinking agent for crosslinking the gel and further increasing the viscosity of the fracturing fluid. The viscosity of a fluid may be any viscosity suitable for a particular application. In some examples the viscosity may be from about 4 cP (centipoise) to about 50 cP. The increased viscosity of the gelled, or gelled and crosslinked, fracturing fluid, inter alia, may reduce fluid loss and may allow the fracturing fluid to transport significant quantities of suspended particulates. The density of the fracturing fluid may be increased to provide additional particle transport and suspension in some applications. The fracturing fluid may further comprise crosslinking agents, gel breaking agents, and any combinations thereof.

In certain systems, methods, and/or compositions of the present disclosure, a friction reducing polymer may be used. The friction reducing polymer may be included in the fracturing fluid to form a slickwater fluid, for example. The friction reducing polymer may be a synthetic polymer. Additionally, for example, the friction reducing polymer may be an anionic polymer or a cationic polymer. By way of example, suitable synthetic polymers may comprise any of a variety of monomeric units, including acrylamide, acrylic acid, 2-acrylamido-2-methylpropane sulfonic acid, N,N-dimethylacrylamide, vinyl sulfonic acid, N-vinyl acetamide, N-vinyl formamide, itaconic acid, methacrylic acid, acrylic acid esters, methacrylic acid esters and combinations thereof. Suitable friction reducing polymers may be in an acid form or in a salt form. As will be appreciated, a variety of salts may be prepared, for example, by neutralizing the acid form of the acrylic acid monomer or the 2-acrylamido-2-methylpropane sulfonic acid monomer. In addition, the acid form of the polymer may be neutralized by ions present in the fracturing fluid. The term “polymer” in the context of a friction reducing polymer, may be intended to refer to the acid form of the friction reducing polymer, as well as its various salts.

The friction reducing polymer may be included in the fracturing fluid, for example, in an amount of about 0.5 GPT to about 10 GPT, about 0.5 GPT to about 5 GPT, or about 5 GPT to about 10 GPT. GPT refers to gallons of additive per thousand gallons of fluid the additive is placed in. The friction reducing polymers may be included in the fracturing fluid in an amount sufficient to reduce friction without gel formation upon mixing. By way of example, the fracturing fluid comprising the friction reducing polymer may not exhibit an apparent yield point. While the addition of a friction reducing polymer may minimally increase the viscosity of the carrier fluid, the friction reducing polymers may generally not be included in the example fracturing fluid in an amount sufficient to substantially increase the viscosity. For example, when proppant particulates are included in the fracturing fluid, velocity rather than fluid viscosity generally may be relied on for proppant transport. Additionally, the friction reducing polymer may be present in an amount in the range from about 0.01% to about 0.15% by weight of the fracturing fluid. Alternatively, the friction reducing polymer may be present in an amount in the range from about 0.025% to about 0.1% by weight of the fracturing fluid. One of ordinary skill in the art with the benefit of this disclosure should be able to select an appropriate carrier fluid for a particular application.

Where foamed, examples of the fracturing fluids may comprise a foaming agent for providing a suitable foam. As used herein, the term “foaming agent” refers to a material or combination of materials that facilitate the formation of a foam in a liquid. Any suitable foaming agent for forming a foam in an aqueous liquid may be used in examples of the treatment fluids. Examples of suitable foaming agents may include, but are not limited to: mixtures of an ammonium salt of an alkyl ether sulfate, a cocoamidopropyl betaine surfactant, a cocoamidopropyl dimethylamine oxide surfactant, sodium chloride, and water; mixtures of an ammonium salt of an alkyl ether sulfate surfactant, a cocoamidopropyl hydroxysultaine surfactant, a cocoamidopropyl dimethylamine oxide surfactant, sodium chloride, and water; hydrolyzed keratin; mixtures of an ethoxylated alcohol ether sulfate surfactant, an alkyl or alkene amidopropyl betaine surfactant, and an alkyl or alkene dimethylamine oxide surfactant; aqueous solutions of an alpha-olefinic sulfonate surfactant and a betaine surfactant; amine oxides, alpha olefin sulfonate, alkylaryl sulfonates, and combinations thereof. An example of a suitable foaming agent is FOAMER™ 760 foamer/stabilizer, HC-2™ agent, and Pen-5M™ foaming agent, all available from Halliburton Energy Services, Inc. Generally, the foaming agent may be present in examples of the foamed treatment fluids in an amount sufficient to provide a suitable foam. In some examples, the foaming agent may be present in an amount in the range of from about 0.8% to about 5% by volume of the treatment fluid.

Proppant particulates may comprise any suitable material. In general proppant particulates should have a crush strength higher than the fracture gradient of the formation so as to avoid crushing the proppant particulates. Proppant particulates should also be resistant to chemical attack from chemicals present in the subterranean formation and from chemicals added to the fracturing fluid. Some suitable proppant particulates without limitation may include silica sand, calcium carbonate sand, resin coated sand, ceramic proppants, fly ash, and sintered bauxite. Other solid particulates suitable of use as proppant particulates may include fly ash, desert sand, beach sand, brown sand, white sand, ceramic beads, glass beads, bauxite grains, sized calcium carbonate, and walnut shell fragments. The proppant particulates may comprise any density. In some examples, proppant particulates may be classified as lightweight or low density and may have a density of about 1.25 g/cm³ to about 2.2 g/cm³. Using low density proppant particulates may have several advantages including but not limited to increased conductivity, easier placing with low viscosity fluids, and more uniform distribution within a fracture. Proppant particulates may comprise any shape, including but not limited, to spherical, toroidal, amorphous, planar, cubic, or cylindrical. Proppant particulates may further comprise any roundness and sphericity. Without limitation, the proppant particulates may have a particle size in a range from about 2 mesh to about 400 mesh, U.S. Sieve Series. By way of example, the proppant particulates may have a particle size of about 10 mesh to about 70 mesh with distribution ranges of 10-20 mesh, 20-40 mesh, 40-60 mesh, or 50-70 mesh, depending, for example, on the particle sizes of the formation particulates to be screen out.

Proppant particulates may be present in the fracturing fluid in any concentration or loading. Without limitation, the proppant particulates may be present in an amount of about 1 pounds per gallon (“lb/gal”) to about 20 lb/gal, about 1 lb/gal to about 5 lb/gal, about 5 lb/gal to about 10 lb/gal, about 10 lb/gal to about 15 lb/gal, about 15 lb/gal to about 20 lb/gal, about 1 lb/gal to about 10 lb/gal, or about 10 lb/gal to about 20 lb/gal. With the benefit of this disclosure, one of ordinary skill in the art should be able to select an appropriate proppant particle and loading.

The fracturing fluid may comprise a dispersing agent. Some examples of dispersants without limitation may include aminosilanes, acacia gum, acrylamide copolymer, acrylate copolymers and their ammonium salts, acrylic acid homopolymer, 2-acrylamido-2-methylpropane sulfonic acid copolymer, carboxylate and sulfonate copolymer, coglycerides, dicaprylyl carbonate, maleic anhydride, phosphinocarboxylic acid, polyacrylic acid, propylheptyl caprylate, sodium acrylate homopolymer, and sodium nitrite. Additional additives may include, but are not limited to, surfactants, friction reducers, lubricants, and consolidating agents. The additives may be present in any concentration. Without limitation, the additives, including the dispersing agents, may be present in an amount of about 1 GPT to about 50 GPT, about 1 GPT to about 10 GPT, about 10 GPT to about 20 GPT, about 20 GPT to about 30 GPT, about 30 GPT to about 40 GPT, about 40 GPT to about 50 GPT, about 1 GPT to about 25 GPT, or about 25 GPT to about 50 GPT. GPT refers to gallons of additive per thousand gallons of fluid the additive is placed in. One of ordinary skill in the art, with the benefit of this disclosure, should be able to select appropriate additives and concentrations for a particular application.

According to some examples of the present invention, a fracture may be created and/or extended by any suitable means. Such means are well-known to those skilled in the relevant art. For example, in some examples, a fracturing fluid, commonly referred to as a pre-pad or pad fluid, may be injected to initiate the fracturing of a subterranean formation prior to the injection of a proppant. In such examples, the pre-pad or pad fluid may be proppant-free or substantially proppant-free. In other examples, the proppant particulates may be suspended in a slurry which may be injected into the subterranean formation to create and/or extend at least one fracture. In order to create and/or extend a fracture, a fracturing fluid is typically injected into the subterranean formation at a rate sufficient to generate a pressure above the fracture gradient.

Traditional fracturing operations can involve packing relatively high volumes of proppant particulates within a fracture. In such operations, a single homogeneous proppant pack is typically formed, which may be used to abut the fracture so that production fluids can be recovered through to the relatively small interstitial spaces between the tightly packed proppant particulates. In some examples of the present application, a fracturing fluid may be introduced into a subterranean formation after the pre-pad or pad fluid. The fracturing fluid may comprise the geopolymer composition and the proppant particulates, wherein the geopolymer composition may be coated on the proppant particulates. The fracturing fluid may be injected in small volumes and alternated between proppant-free and proppant-laden fluid. The proppant-free fluid intermittently injected into the fracture with the fracturing fluid that is proppant laden will be referred to herein as a “spacer fluid.” This spacer fluid may be an aqueous gel, for example, comprising an aqueous base fluid, a gelling agent, and an optional crosslinking agent. The spacer fluid may be the same fluid as the fracturing fluid comprising the proppant particulates. The alternating of proppant-free and proppant-laden fluid may form a plurality of proppant aggregates surrounded by spacer fluid. In some examples, the spacer fluid may be a cross-linked gel. The proppant aggregates may be allowed to set in the formation, effectively consolidating the aggregates. If the spacer fluid is cross linked, a breaker (e.g., oxidizers) may break the spacer fluid and decrease the viscosity. The well may be back flowed to allow the broken spacer fluid to exit the formation thereby forming proppant free channels surrounding the consolidated proppant aggregates and connecting the high conductive propped fracture with the wellbore.

A method of treating a subterranean formation may comprise creating at least one fracture in the subterranean formation, providing a fracturing fluid comprising proppant particulates and a geopolymer composition coated on the proppant particulates, wherein the geopolymer composition comprises an aluminosilicate source, a metal silicate source, and an activator, alternately injecting a spacer fluid and the fracturing fluid into the fracture such that a plurality of proppant aggregates are disposed in the fracture surrounded by the spacer fluid, wherein the proppant aggregates each comprise a portion of the proppant particulates coated with a volume of the geopolymer composition; and allowing the geopolymer composition to set in the formation such that the proppant aggregates gain consolidation strength. Creating the fracture may comprise injecting a fracturing fluid that is proppant-free into the subterranean formation at a pressure that is above a fracture gradient. The step of providing a fracturing fluid comprising proppant particulates and a geopolymer composition may comprise coating the geopolymer composition on the proppant particulates while blending the proppant particulates with a base fluid to form the fracturing fluid. A dry blend of the geopolymer composition may be combined with the base fluid. The spacer fluid may comprise water, a gelling agent, a crosslinking agent, and a breaker. The method may further comprise allowing the spacer fluid to break after the step of allowing the geopolymer composition to set in the formation. The method may further comprise flowing back the spacer fluid from the from the fracture, after the step of allowing the spacer fluid to break, to remove at least a portion of the spacer fluid from the fracture such that proppant-free channels are formed surrounding the proppant aggregates. The fracturing fluid may be transported into the subterranean formation through a tubular and the spacer fluid may be transported into the subterranean formation through an annulus between the tubular and the subterranean formation. The geopolymer composition may be present in an amount of about 9 pounds per gallon to about 20 pounds per gallon of the fracturing fluid. Allowing the geopolymer to set may comprise a reaction that comprises aluminosilicates to form a geopolymer. The proppant particulates may be selected from the group consisting of silica sand, calcium carbonate sand, resin coated sand, ceramic, fly ash, and sintered bauxite, glass beads, bauxite grains, sized calcium carbonate, and walnut shell fragments.

A fracturing fluid may comprise: a base fluid; proppant particulates; and a geopolymer composition wherein the geopolymer composition is coated on the proppant particulates, wherein the geopolymer composition comprises an aluminosilicate source, a metal silicate source, and an alkali activator. The fracturing fluid may further comprise a gelling agent and a crosslinking agent, wherein the base fluid comprises water. The fracturing fluid proppant particulates may be present in an amount of about 9 pounds per gallon to about 20 pounds per gallon of the fracturing fluid. The fracturing fluid geopolymer may be present in an amount of about 9 pounds per gallon to about 20 pounds per gallon of the fracturing fluid. The fracturing fluid proppant particulates may be selected from the group consisting of silica sand, calcium carbonate sand, resin coated sand, ceramic, fly ash, and sintered bauxite, glass beads, bauxite grains, sized calcium carbonate, and walnut shell fragments.

A system for fracturing in a subterranean formation may comprise: a fracturing fluid comprising a base fluid, a geopolymer composition, and proppant particulates, wherein the geopolymer composition is coated on the proppant particulates, wherein the geopolymer composition comprises an aluminosilicate source, a metal silicate source, and an alkali activator; mixing equipment capable of mixing the fracturing fluid; and pumping equipment capable of pumping the fracturing fluid. The fracturing fluid may comprise water, a gelling agent, and a crosslinking agent. The proppant particulates may be present in an amount of about 9 pounds per gallon to about 20 pounds per gallon of the fracturing fluid, wherein the geopolymer may be present in an amount of about 9 pounds per gallon to about 20 pounds per gallon of the fracturing fluid, and wherein the proppant particulates are selected from the group consisting of silica sand, calcium carbonate sand, resin coated sand, ceramic, fly ash, and sintered bauxite, glass beads, bauxite grains, sized calcium carbonate, and walnut shell fragments. The spacer fluid may be the form of an aqueous gel.

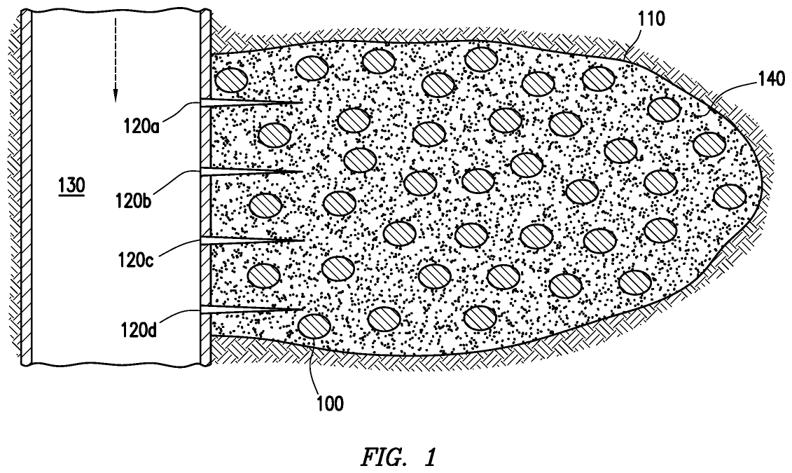

Referring to FIG. 1, proppant aggregates 100 are shown disposed in fracture 110. Proppant aggregates 100 may suspended in fracturing fluid 140 have been transported into fracture 110 through perforations 120 a-d on a casing or liner 130 that spans the wellbore, including zones containing the fracture 110. As previously described, the proppant aggregates may comprise proppant particulates coated with a geopolymer composition. The geopolymer composition may adhere the proppant particulates to one another. Perforations 120 a-d can be formed by any suitable means including, but not limited to, jet perforating guns equipped with shaped explosive charges, abrasive jetting, and high-pressure fluid jetting.

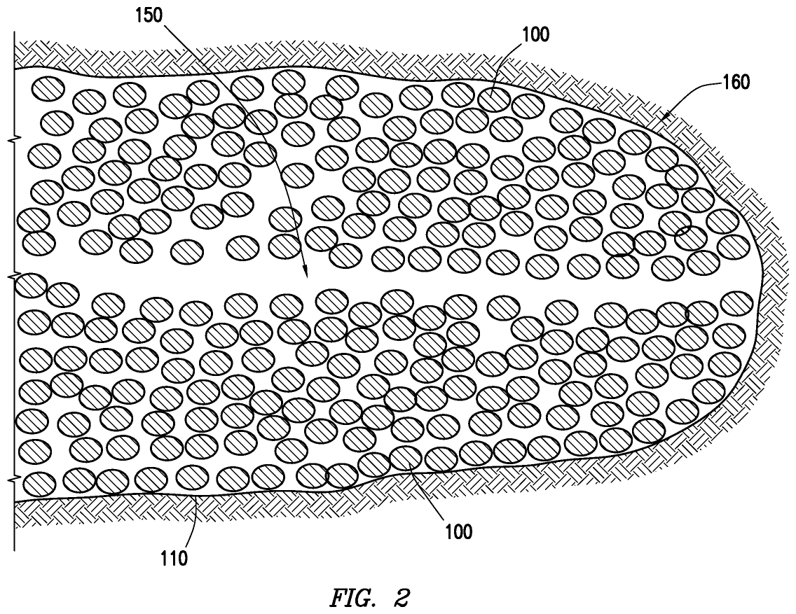

Referring to FIG. 2, a channel 150 may be formed within fracture 110. As shown, the channel 150 may be proppant-free and should allow relatively unimpeded flow of fluids. The channel 150 more spacious than the interstitial spaces that are typically formed within proppant packs. As previously described, the channel 150 may be formed by back flowing spacer fluid from the fracture 110. The proppant aggregates 100 may have consolidated to form permeable mass 160. Permeable mass 160 may be a substantially rigid mesh that is permeable to gas and formation fluids.

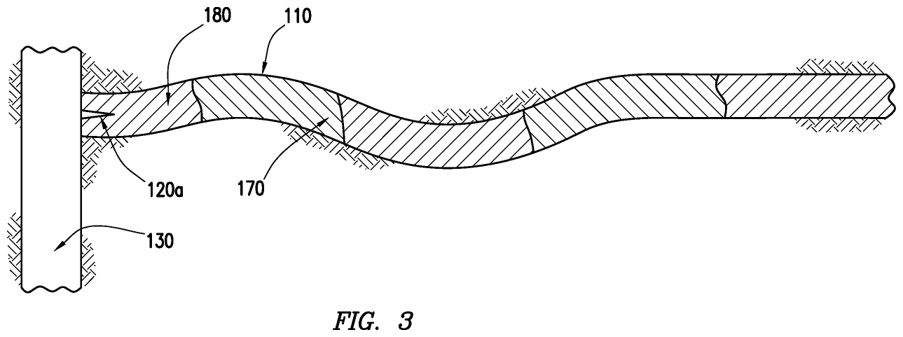

Referring to FIG. 3, during a treatment operation, spacer fluid 170 and fracturing fluid 180 may be alternatively pumped in small volumes into fracture 110 through perforation 120a. During a treatment operation, the total volume of fluid pumped per minute may be about 10 barrels per minute (bpm) to about 100 bpm. In some examples, the small volumes of fracturing fluid alternately pumped may be about 2 barrels to about 25 barrels. As previously described, spacer fluid 170 may be proppant-free and fracturing fluid 180 may comprise a geopolymer composition and proppant particulates. It should be noted that although only perforation 120a is illustrated, the spacer fluid 170 and fracturing fluid 180 may flow through any perforations present.

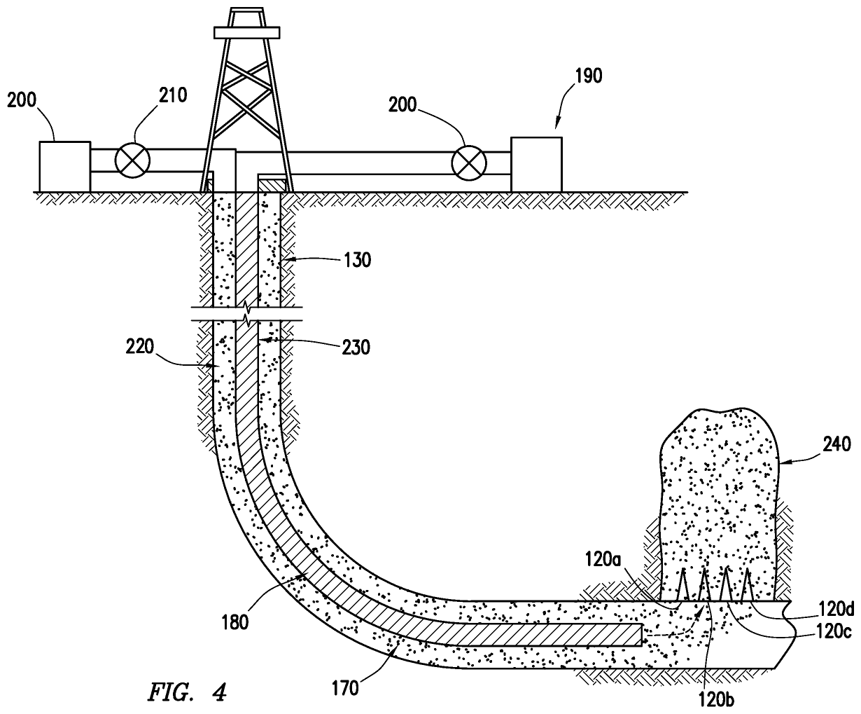

Referring to FIG. 4, an example of a well system 190 for introduction of the spacer fluid 170 and proppant-laden fracturing fluid 180 is shown. As shown, the well system 190 may comprise first mixing equipment 200 and first pumping equipment 210. The first mixing equipment 200 may be used to mix the spacer fluid 170. The first pumping equipment 210 may be fluidically coupled to first mixing equipment 200 and to annulus 220 created between casing or liner 130 and tubulars 230. First pumping equipment 210 may be deliver spacer fluid 170 to annulus 220, where it may be conveyed into subterranean formation 240 through perforations 120a-d. Well system 190 may further comprise second mixing equipment 250 and second pumping equipment 260. Second mixing equipment 250 may mix the fracturing fluid 180, which may comprise the proppant particulates and geopolymer composition. The second pumping equipment 260 may be fluidically coupled to second mixing equipment 250 and tubular 230. Second pumping equipment 260 may deliver fracturing fluid 180 to tubular 210, where it may be conveyed into subterranean formation 240 through perforations 120a-d. Alternatively, fracturing fluid 180 may be conveyed through annulus 220, spacer fluid 170 may convey through tubular 210. In another alternative, fracturing fluid 180 and spacer fluid 170 may both be conveyed through annulus 220 or both through tubular 210. The spacer fluid 170 and fracturing fluid 180 may both be introduced above the fracture gradient of subterranean formation 240. While not shown on FIG. 4, one or more fractures (e.g., fracture 110 on FIG. 1) may have previously been created in subterranean formation 240 such that the spacer fluid 170 and fracturing fluid 180 may be introduced into the fractures.

The first pumping equipment 210 and second pumping equipment 260 may include a high pressure pump. As used herein, the term “high pressure pump” refers to a pump that is capable of delivering the fracturing fluid 180 downhole at a pressure of about 1000 psi or greater. A high pressure pump may be used when it is desired to introduce the fracturing fluid 180 into subterranean formation 240 at or above a fracture gradient of the subterranean formation 120, but it may also be used in cases where fracturing is not desired. Suitable high pressure pumps may include, but are not limited to, floating piston pumps and positive displacement pumps.

Alternatively, the first pumping equipment 210 and second pumping equipment 260 may include a low pressure pump. As used herein, the term “low pressure pump” refers to a pump that operates at a pressure of about 1000 psi or less. A low pressure pump may be fluidly coupled to a high pressure pump that may be fluidly coupled to tubular 230 or annulus 220, for example. The low pressure pump may be configured to convey the spacer fluid 170 or fracturing fluid 180 to the high pressure pump. The low pressure pump may “step up” fluid pressure before it reaches the high pressure pump.

First mixing equipment 200 and second mixing equipment 250 may include a mixing tank that is upstream of the first pumping equipment 210 and/or second pumping equipment 260 and in which the spacer fluid 170 and/or fracturing fluid 180 may be formulated. Alternatively, the spacer fluid 170 and/or fracturing fluid 180 may be formulated offsite and transported to a worksite, in which case the spacer fluid 170 and/or fracturing fluid 180 may be introduced to the tubular 230 and/or annulus 220 directly from its shipping container (e.g., a truck, a railcar, a barge, or the like) or from a transport pipeline.

### EXAMPLES

To facilitate a better understanding of the present disclosure, the following example is given. In no way should such examples be read to limit, or to define, the scope of the disclosure.

A geopolymer composition was prepared by measuring 18.6 grams of aluminum silicate, 13.4 grams of sodium silicate, and 10 ml of 7% KCl into a container and thoroughly mixing until homogeneous. A 50 gram sample of 20/40 mesh northern white sand was measured into a separate container. A 30 gram sample of the geopolymer composition was withdrawn from the first container and thoroughly mixed with the sand in the second container. The mixed sand and geopolymer was packed into a mold and cured for 28 hours at 200° F. After curing the core was removed and subjected to UCS (unconfined compressive strength) testing. The compressive strength was determined to be over 3000 psi.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method of treating a subterranean formation comprising:
creating at least one fracture in the subterranean formation;
providing a fracturing fluid comprising proppant particulates and a geopolymer composition coated on the proppant particulates, wherein the geopolymer composition comprises an aluminosilicate source, a metal silicate source, and an activator;
alternately injecting a spacer fluid and the fracturing fluid into the fracture such that a plurality of proppant aggregates are disposed in the fracture surrounded by the spacer fluid, wherein the proppant aggregates each comprise a portion of the proppant particulates coated with a volume of the geopolymer composition; and
allowing the geopolymer composition to set in the formation such that the proppant aggregates gain consolidation strength.

2. The method of claim 1 wherein creating the fracture comprises injecting a fracturing fluid that is proppant-free into the subterranean formation at a pressure that is above a fracture gradient.

3. The method of claim 1 wherein providing a fracturing fluid comprising proppant particulates and a geopolymer composition comprises coating the geopolymer composition on the proppant particulates while blending the proppant particulates with a base fluid to form the fracturing fluid.

4. The method of claim 3, wherein a dry blend of the geopolymer composition is combined with the base fluid.

5. The method of claim 1 wherein the spacer fluid comprises water, a gelling agent, a crosslinking agent, and a breaker.

6. The method of claim 1 further comprising allowing the spacer fluid to break after the step of allowing the geopolymer composition to set in the formation.

7. The method of claim 6 further comprising flowing back the spacer fluid from the from the fracture, after the step of allowing the spacer fluid to break, to remove at least a portion of the spacer fluid from the fracture such that proppant-free channels are formed surrounding the proppant aggregates.

8. The method of claim 1 wherein the fracturing fluid is transported into the subterranean formation through a tubular and the spacer fluid is transported into the subterranean formation through an annulus between the tubular and the subterranean formation.

9. The method of claim 1 wherein the geopolymer composition is present in an amount of about 9 pounds per gallon to about 20 pounds per gallon of the fracturing fluid.

10. The method of claim 1 wherein the allowing the geopolymer to set comprises a reaction that comprises aluminosilicates to form a geopolymer.

11. The method of claim 1 wherein the proppant particulates are selected from the group consisting of silica sand, calcium carbonate sand, resin coated sand, ceramic, fly ash, and sintered bauxite, glass beads, bauxite grains, sized calcium carbonate, and walnut shell fragments.

12. A fracturing fluid comprising:
a base fluid;
proppant particulates; and
a geopolymer composition wherein the geopolymer composition is coated on the proppant particulates, wherein the geopolymer composition comprises an aluminosilicate source, a metal silicate source, and an alkali activator.

13. The fracturing fluid of claim 12 further comprising a gelling agent and a crosslinking agent, wherein the base fluid comprises water.

14. The fracturing fluid of claim 12 wherein the proppant particulates are present in an amount of about 9 pounds per gallon to about 20 pounds per gallon of the fracturing fluid.

15. The fracturing fluid of claim 12 wherein the geopolymer is present in an amount of about 9 pounds per gallon to about 20 pounds per gallon of the fracturing fluid.

16. The fracturing fluid of claim 12 wherein the proppant particulates are selected from the group consisting of silica sand, calcium carbonate sand, resin coated sand, ceramic, fly ash, and sintered bauxite, glass beads, bauxite grains, sized calcium carbonate, and walnut shell fragments.

17. A system for fracturing in a subterranean formation comprising:
a fracturing fluid comprising a base fluid, a geopolymer composition, and proppant particulates, wherein the geopolymer composition is coated on the proppant particulates, wherein the geopolymer composition comprises an aluminosilicate source, a metal silicate source, and an alkali activator;
mixing equipment capable of mixing the fracturing fluid; and
pumping equipment capable of pumping the fracturing fluid.

18. The system of claim 17 wherein the fracturing fluid comprises water, a gelling agent, and a crosslinking agent.

19. The system of claim 17, wherein the proppant particulates are present in an amount of about 9 pounds per gallon to about 20 pounds per gallon of the fracturing fluid, wherein the geopolymer is present in an amount of about 9 pounds per gallon to about 20 pounds per gallon of the fracturing fluid, and wherein the proppant particulates are selected from the group consisting of silica sand, calcium carbonate sand, resin coated sand, ceramic, fly ash, and sintered bauxite, glass beads, bauxite grains, sized calcium carbonate, and walnut shell fragments.

20. The system of claim 18, further comprising a spacer fluid in the form of an aqueous gel.
